(19) United States
(12) Patent Application Publication
(10) Pub. No.: US 2015/0201554 A1
(43) Pub. Date: Jul. 23, 2015

(54) BRUSH ATTACHMENT FOR GREENS MOWER

(71) Applicant: William John McCarthy, Palm City, FL (US)

(72) Inventor: William John McCarthy, Palm City, FL (US)

(21) Appl. No.: 14/159,510

(22) Filed: Jan. 21, 2014

(51) Int. Cl. A01D 34/00; A01D 34/835

(52) U.S. Cl. CPC A01D 34/001; A01D 34/835

(57) ABSTRACT

A brush attachment is provided. The brush attachment includes a mounting frame configured to mount to the front of a greens mower. A pair of arms may be pivotally attached to the mounting frame and may extend downwards towards a surface in which the mower is resting. A brush frame having bristles may be attached to the arms. Therefore, a user may cut the grass on the putting green of a golf course so that the brush fluffs the grass uniformly and then the mower cuts the grass evenly.

### BACKGROUND OF THE INVENTION

The present invention relates to brush attachment and, more particularly, to a brush attached to the front of a Golf Course Greens Mower.

The putting green is an area of the golf course requiring very precisely cut turf on smooth, firm ground surrounding the hole. The cutting process is very precise being done using measurements of 1,000 of an inch. The turf of the green is cut daily in order to obtain optimum performance. The putting surface must be precisely maintained so that players can make the precision strokes to put the ball in the hole. The green is surrounded by turf of varying lengths according to location.

As can be seen, there is a need for devices that aid in the cutting and maintenance of a golf course putting green.

### SUMMARY OF THE INVENTION

In one aspect of the present invention, a brush attachment comprises: a mounting frame configured to attach to the front of a greens mower; at least one arm attached to the mounting frame and directed downward towards a surface in which the greens mower is resting; a brush frame attached to the at least one arm, wherein the brush frame comprises bristles.

In another aspect of the present invention, a method of preparing a golf course green comprises: mounting a brush to a front end of a lawn mower so that the brush is brushing in front of a surface that the lawn mower is riding on; and riding the lawn mower on a green of a golf course, and thereby fluffing up the grass on the green and evenly cutting the grass in a uniform pattern.

These and other features, aspects and advantages of the present invention will become better understood with reference to the following drawings, description and claims.

### BRIEF DESCRIPTION OF THE DRAWINGS

FIG. 1 is a perspective view of the present invention;

FIG. 2 is a side view of the present invention;

FIG. 3 is a top view of the present invention; and

FIG. 4 is a front view of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a brush attachment. The brush attachment includes a mounting frame configured to mount to the front of a greens mower. A pair of arms may be pivotally attached to the mounting frame and may extend downwards towards a surface in which the mower is resting. A brush frame having bristles may be attached to the arms. Therefore, a user may cut the grass on the putting green of a golf course so that the brush fluffs the grass uniformly and then the mower cuts the grass evenly.

The present invention includes a brush attachment for golf course greens mowers. The present invention may include an aluminum frame and mount. The present invention may be mounted to the front of the mower and may brush against the individual plants into an erect and more uniform pattern, allowing the mower to cut in a more precise manner. This, in turn, creates a more uniform and better putting surface. The bristle pattern, density, gauge, and type may be adjusted to the user's needs.

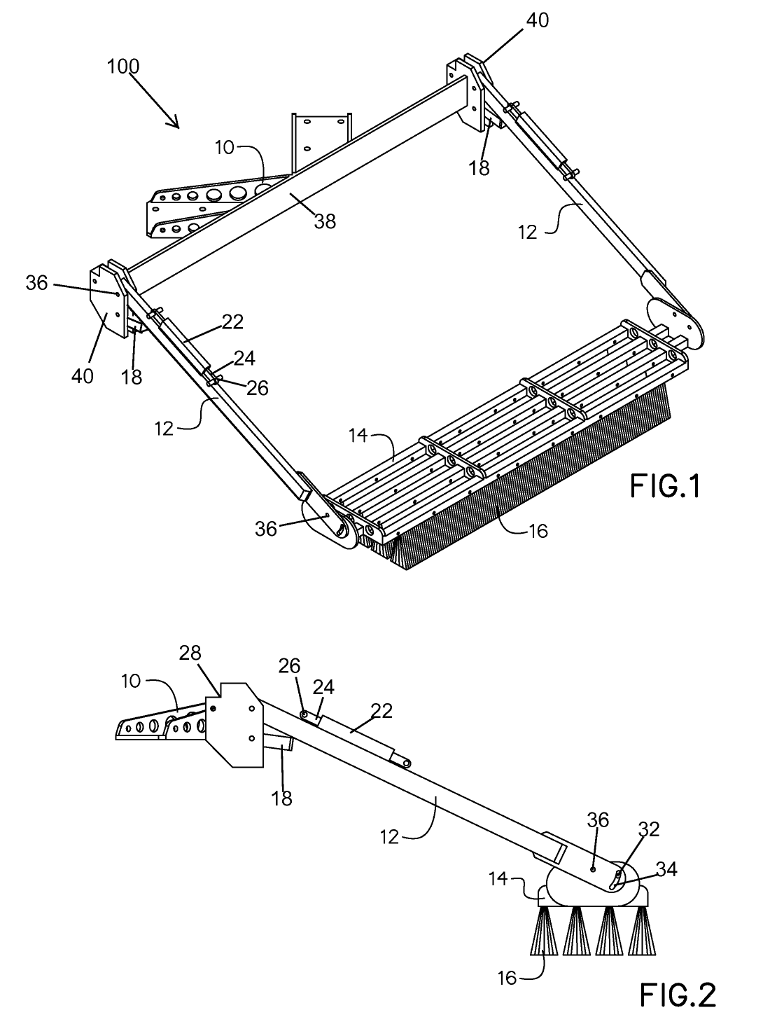

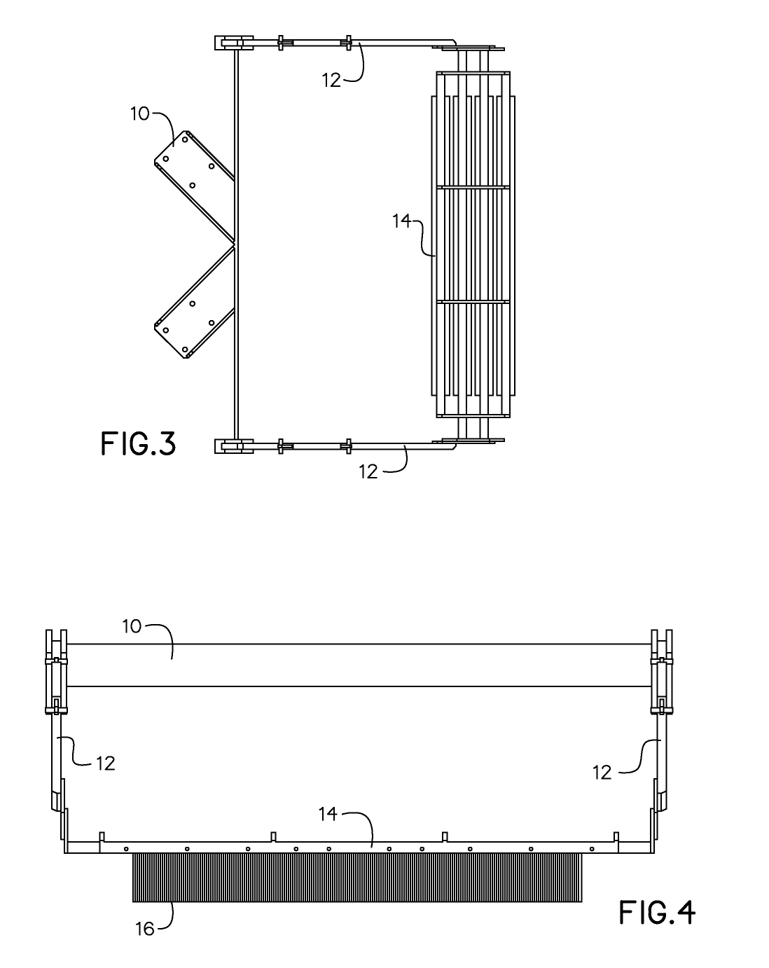

Referring to FIGS. 1 through 4, the present invention includes a brush attachment 100. The brush attachment 100 includes a mounting frame 10. The mounting frame 100 may connect with the front of a mower, such as a riding greens mower. The brush attachment 100 may further include at least one arm 12 extending from the mounting frame 10 and may be directed downwards towards a surface in which the greens mower is resting on. Attached to the at least one arm 12 is the brush frame 14 which includes bristles 16. Therefore, the user may ride the mower with the bristles 16 brushing against the grass of the green, erecting the grass that is about to be cut.

The at least one arm 12 of the present invention may include a first arm 12 and a second arm 12. The present invention may further include a front plate 38 that is attached to the mounting frame 100. The front plate 38 may include a first end and a second end. The first end may include a first side connector 40 and the second end may include a second side connector 40. In certain embodiments, the first arm 12 may be pivotally connected to the first side connector 40 by a hinge 36 and the second arm 12 may be pivotally connected to the second side connector 40 by another hinge 36.

In certain embodiments of the present invention, the brush attachment 100 may be adjustable to work with different sized mowers and different types of terrain. For example, the angle of the brush frame 14 relative to the first arm 12 and the second arm 12 may be adjustable. In such embodiments, the first arm 12 and the second arm 12 may each include a slot 34. The brush frame 14 may include a bolt 32 at either end near the connection of the arms 12 and the brush frame 14. The bolt 32 may fit within the slot 34. The bolt 32 may be in a fixed position in which a nut may be screwed and tightened so that the brush frame 14 and the arms 12 are in a fixed position relative to one another. Alternatively, the nut may be loosened so that the bolt 32 may slide within the slot 34 and the angle of the brush frame 16 may be adjusted and then the nut may be tightened in place.

The present invention may further include at least one adjustable stopper 18. The stopper 18 may extend from at least one of the side connectors 40 below at least one of the arms 12. For example, the stopper 18 may extend from both of the side connectors 40 and below both of the arms 12. The stoppers 18 may prevent the arms 12 from pivoting further in a downward direction. The stoppers 18 may be adjusted to extend further from or retract within the side connectors 40. Therefore, the downward angle of the arms 12 relative to the greens mower may be adjusted.

In certain embodiments, the present invention may be in a stowed position and a deployed position. For example the brush attachment 100 may be in a stowed position in an upright position. In such embodiments, the present invention may include a latch component 20 that secures the brush attachment 100 in the upright position. The latch component 20 may be connected to the arms 12 and may include a housing 22, and a lock slide 24 within the housing 22. The lock slide 24 may include a first end and a second end extending outside of the housing 22. The first end and the second end may include pins 26 preventing the lock slide 24 from sliding out of the housing 22. The stowed or upright position may include the arms 12 pivoted upward so that the latch slide 24 slides into and rests against a latch stop 28 on the side connectors 40, thereby securing the at least one arm 12 in the upright and stowed position. Further, the arms 12 may be pivoted downward to deploy the brush attachment 100.

A method of preparing a golf course green may include mounting a brush to a front end of a lawn mower so that the brush is brushing in front of a surface that the lawn mower is riding on; and riding the lawn mower on a green of a golf course, and thereby fluffing up the grass on the green and evenly cutting the grass in a uniform pattern.

It should be understood, of course, that the foregoing relates to exemplary embodiments of the invention and that modifications may be made without departing from the spirit and scope of the invention as set forth in the following claims.

What is claimed is:

1. A brush attachment comprising:
a mounting frame configured to attach to the front of a greens mower;
at least one arm attached to the mounting frame and directed downward towards a surface in which the greens mower is resting;
a brush frame attached to the at least one arm, wherein the brush frame comprises bristles.

2. The brush attachment of claim 1, wherein the at least one arm comprises a first arm and a second arm.

3. The brush attachment of claim 2, further comprising a front plate attached to the mounting frame, wherein the front plate comprises a first end comprising a first side connector and a second end comprising a second side connector.

4. The brush attachment of claim 3, wherein the first arm is pivotally connected to the first side connector and the second arm is pivotally connected to the second side connector.

5. The brush attachment of claim 2, wherein the angle of the brush frame relative to the first arm and the second arm is adjustable.

6. The brush attachment of claim 2, wherein the first arm and the second arm comprise a slot, and the brush frame comprises a bolt that fits within the slot, wherein the bolt transferable from a fixed position within the slot and a moveable position within the slot for adjustment.

7. The brush attachment of claim 4, further comprising a latch component attached to the at least one arm configured to secure the at least one arm in an upright position.

8. The brush attachment of claim 7, wherein the latch component comprises a housing, and a lock slide within the housing, wherein the lock slide comprises a first end and a second end extending outside of the housing, wherein the first end and the second end comprise pins preventing the lock slide from sliding out of the housing.

9. The brush attachment of claim 8, wherein the upright position comprises the at least one arm pivoted upward so that the latch slide slides into and rest against a latch stop on the side connector, thereby securing the at least one arm in the upright position.

10. The brush attachment of claim 3, further comprising at least one adjustable stopper extending from at least one of the side connectors below the at least one arm, preventing the at least one arm from pivoting further in a downward direction.

11. The brush attachment of claim 1, further comprising the greens mower, wherein the brush attachment is attached to the front of the greens mower,

12. A method of preparing a golf course green comprising:
mounting a brush to a front end of a lawn mower so that the brush is brushing in front of a surface that the lawn mower is riding on; and
riding the lawn mower on a green of a golf course, and thereby fluffing up the grass on the green and evenly cutting the grass in a uniform pattern.
